(19) United States
(12) Patent Application Publication
(10) Pub. No.: US 2022/0114361 A1
(43) Pub. Date: Apr. 14, 2022

(54) MULTI-WORD CONCEPT TAGGING FOR IMAGES USING SHORT TEXT DECODER

(71) Applicant: Adobe Inc., San Jose, CA (US)

(72) Inventors: Ajinkya KALE, San Jose, CA (US); Pranav AGGARWAL, San Jose, CA (US)

(21) Appl. No.: 17/070,566

(22) Filed: Oct. 14, 2020

(51) Int. Cl. G06K 9/00; G06F 40/169; G06F 40/289; G06K 9/62; G06N 20/00; G06F 16/51; G06F 16/53

(52) U.S. Cl. CPC G06K 9/00456; G06F 40/169; G06F 40/289; G06F 16/53; G06N 20/00; G06F 16/51; G06K 9/6257

(57) ABSTRACT

Embodiments are disclosed for training an image caption generator model to generate phrase tags for input images. The phrase tags can include short phrases that describe the contents of the images (e.g., objects depicted therein). Once trained, the image caption generator model can be used as an image phrase tagger to tag input images from an image library with phrase tags. The image library can be indexed based on their phrase tags. Subsequently, when the image library is queried, the query can be divided into phrases and the index can be used to identify matching images.

### BACKGROUND

Recent years have seen rapid technological development in the area of digital visual media searching. Indeed, as a result of the proliferation of personal computing devices and digital cameras, individuals and businesses now routinely manage large repositories of digital images and digital videos. Accordingly, digital visual media searching has become a ubiquitous need for individuals and businesses in a variety of scenarios ranging from casual users seeking to locate specific moments from a personal photo collection to professional graphics designers sorting through stock images to enhance creative projects.

In response, developers have created a variety of digital searching systems that can search digital visual media. Conventional digital searching systems often provide search by text-based searches (i.e., systems that utilize a keyword to search a repository of digital images). In such tag-based systems, images in an image library are associated with one or more single-word tags. Such single-word tags fail to fully capture the description of the image from which the tags were derived. Accordingly, it is difficult to search such a tagged library for anything more complex than a single tag. As such, conventional digital search systems generally lack the ability to return accurate search results for complex queries.

These and other problems exist with regard to image search in electronic systems.

### SUMMARY

Introduced here are techniques/technologies that provide benefits and/or solve one or more of the foregoing or other problems in the art with systems and methods that search for and identify digital visual media based on complex queries. In particular, in one or more embodiments, the disclosed systems and methods utilize deep learning techniques to generate multi-word phrase tags for images in an image library. An image caption generator model can be trained to generate short descriptive phrases that describe the contents of the images. Once the model has been trained, it can be used to generate phrase tags for an image library. The phrase tags can include noun phrases, so each phrase tag includes a noun and a modifier. For example, an image of a black rose on a white background may be tagged with two phrase tags: “black rose” and “white background.”

The images in the image library can be indexed using their phrase tags. Unlike conventional single word tags, phrase tags retain the context of the tags. Queries to the image library can be broken up into phrases and images are identified based on the phrase index. This provides a more accurate result set that reflects the meaning of the query.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of multi-word phrase tagging of digital media in accordance with one or more embodiments;

FIG. 2 illustrates a diagram of a process of generating training phrases from training data in accordance with one or more embodiments;

FIG. 3 illustrates a diagram of a process of training an image phrase tagger in accordance with one or more embodiments;

FIG. 4 illustrates a diagram of a process of generating a phrase index for an image library in accordance with one or more embodiments;

FIG. 5 illustrates a diagram of a process of querying phrase-tagged images using a phrase index in accordance with one or more embodiments;

FIG. 6 illustrates a diagram of example query processing in accordance with one or more embodiments;

FIG. 7 illustrates a schematic diagram of a digital media search system in accordance with one or more embodiments;

FIG. 8 illustrates a flowchart of a series of acts in a method of multi-word phrase tagging of digital media in accordance with one or more embodiments;

FIG. 9 illustrates a flowchart of a series of acts in a method of searching digital media using multi-word phrase tags in accordance with one or more embodiments;

FIG. 10 illustrates a schematic diagram of an exemplary environment in which the image processing system can operate in accordance with one or more embodiments; and

FIG. 11 illustrates a block diagram of an exemplary computing device in accordance with one or more embodiments.

### DETAILED DESCRIPTION

One or more embodiments of the present disclosure include a digital media search system that uses machine learning (ML) to generate short descriptive phrases that describe digital media (e.g., digital images, digital videos, etc.). The digital media search system then uses these ML-generated phrases to create multi-word tags (e.g., “phrase tags”) which are used to index the digital media. The ability to accurately search through image and video libraries is important to digital designers as well as casual users. However, traditionally tagged media libraries are based on tags generated by autotaggers. Autotaggers typically rely on a finite vocabulary and are limited to single-word tags. If a digital media item (e.g., image or video) includes representations of multiple objects with unique attributes, any association between the objects and their attributes is lost when the single-word tags are generated for the image. Similarly, when such a tagged library is searched, a tag-based image search pipeline first converts the user text query into bag of tags and then retrieves matching images based on the image tags. Because the relationship between the tags is lost both when the images are tagged and in query processing, very different queries can yield similar or identical results.

Embodiments address these shortcomings in traditional systems through the use of phrase tags. Phrase tags are generated by the digital media search system and retain the associations between words in the ML-generated phrases from which they were derived. When a query is received, it can be parsed into descriptive phrases (e.g., query phrases). These query phrases can then be matched to phrase tags using the phrase tag index to identify images that match the query phrases. Because the associations between the words in the phrase tags and the query tags are retained, the query results more accurately reflect the intention of the query, resulting in a more accurate result set and better user experience.

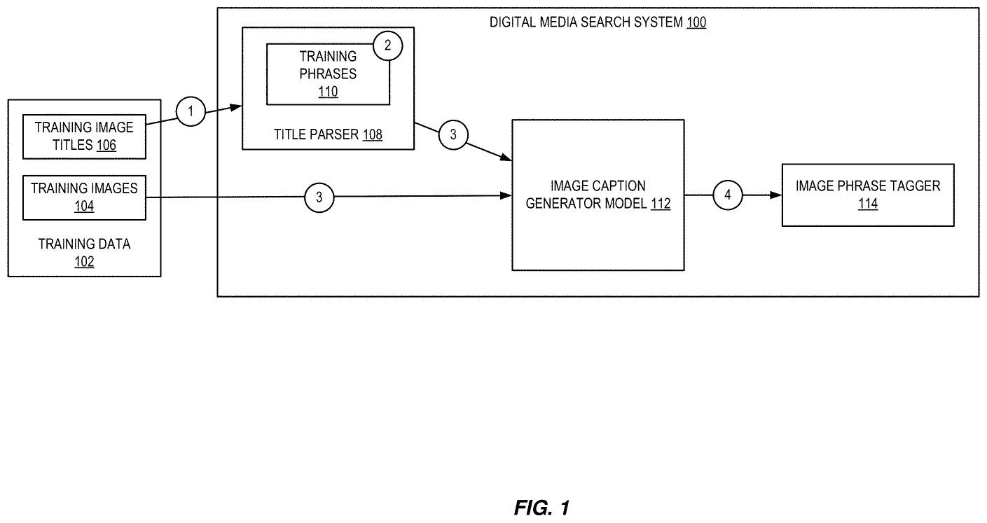

FIG. 1 illustrates a diagram of a process of multi-word phrase tagging of digital media in accordance with one or more embodiments. As discussed, typical digital media search systems include tags in digital media metadata of the digital media items in a digital media library which are used for searching that library. For example, the titles of the digital media items may be tokenized into one-word tags and added to each corresponding item's metadata. However, if there are multiple objects represented in the digital media item, the tags lose the association between the words (e.g., which attribute modifies which depicted object). As a result, for example, a digital image of a white rose on a black background will have the same tags as a digital image of a black rose on a white background (e.g., “white” “rose” “black” “background”). Likewise, a query for a black rose on a white background and a query for a white rose on a black background will be tokenized to the same search terms. As such, either query will yield the same result set, requiring the user to search through a significant number of results that are non-responsive to their query. Similarly, a query for “milk chocolate” and a query for “chocolate milk” will both be tokenized to “milk” and “chocolate” and the context of which word is the modifier will be lost. Accordingly, the result set will be identical for both queries, with a significant number of irrelevant search results for both queries.

As shown in FIG. 1, a digital media search system 100 can train an image phrase tagger 114 to automatically generate phrase tags for input images. During the training phase, training data 102 can be obtained by the digital media search system 100. The training data 102 can be training data maintained, curated, compiled, or otherwise organized by the digital media search system. Additionally, or alternatively, the training data 102 can be obtained from another entity, such as an image service that maintains an image library, such as a stock photo service. The training data 102 can be curated to represent a broad variety of objects and/or scenes. Alternatively, the training data 102 can be curated to represent a specific class or classes of objects or scenes (e.g., species of birds, pets, landscapes, cityscapes, etc.). The training data can include pairs of training images 104 and training image titles 106. The training image titles can include short descriptive phrases (e.g., one to three word phrases). The training data 102 can be stored locally on digital media search system 100, available to digital media search system 100 via removable media, accessible over one or more networks (e.g., via an endpoint in a storage service implemented by a cloud computing service, etc.).

At numeral 1, the training image titles 106 can be received by a title parser 108. The title parser can include a natural language processing (NLP) system that can perform dependency parsing. Dependency parsing uses the syntax of the language of the training image title to identify phrases (also referred to as chunks). For example, the dependency parser can generate a dependency tree that indicates how each word in the title is related to at least one other word. For example, the dependency tree may represent the syntactic relationship between words. Based on the dependency tree, the title parser can identify training phrases 110, such as noun phrases (e.g., a noun and any modifiers), at numeral 2.

At numeral 3, the training phrases 110 and training images 104 can be provided to an image caption generator model 112. Image caption generator model 112 may be a neural network which learns to automatically describe the content of an image. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In some embodiments, the image caption generator model 112 may be a long short-term memory (LSTM) model. In some embodiments, the image caption generator model 112 may include a convolutional neural network for vision tasks followed by a recurrent neural network for language generation tasks.

Once trained, when the image caption generator model 112 is presented with an image it generates a caption for the image describing what is represented in the image. Because the image caption generator model 112 is trained using short training phrases, it learns to output short phrases that describe the objects represented in the image. As such, rather than generating a full caption of an input image, the image caption generator model 112 is trained such that it outputs descriptive phrases. Training may be performed over a number of epochs until the image caption generator model 112 converges (e.g., performs better than a desired accuracy threshold) at which point the trained model can be provided as an image phrase tagger 114, as shown at numeral 4.

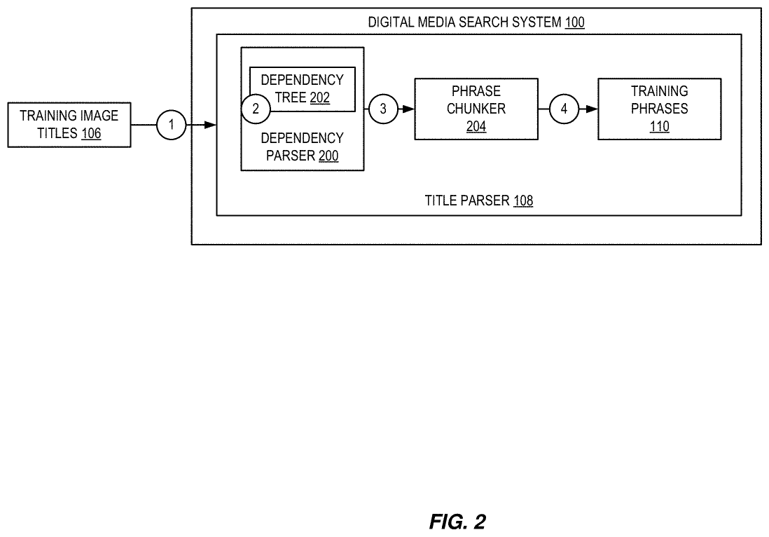

FIG. 2 illustrates a diagram of a process of generating training phrases from training data in accordance with one or more embodiments. As shown in FIG. 2, training phrases 110 can be generated using a title parser 108. Training image titles 106 can be received by title parser 108 at numeral 1. The training image titles can be obtained from an existing curated training data set, added as annotations by one or more human annotators, etc. In some embodiments, the training titles are ground truth labels for the contents of the corresponding training images. As discussed, the training image titles can include short (e.g., one to three word) phrases that describe what is depicted in corresponding training images.

A dependency parser 200 of title parser 108 can build a dependency tree for a first training image title 106. The dependency parser can include an NLP library that tokenizes the input text (e.g., a training title) and then identifies the part of speech of each token based on a semantic model of the language of the input text. Additionally, the dependency parser 200 can identify the dependencies between two or more words in the input text. For example, the dependency parser can identify an adjective that modifies a noun, a noun that is the subject of a verb, an adverb that modifies a verb, etc. Based on these relationships, at numeral 2, the dependency parser can build the dependency tree 202. In some embodiments, each node in the dependency tree 202 can represent a token (e.g., word) of the input text. In some embodiments, each node is associated with metadata about the semantic characteristics of the token, such as a part of speech tag. Each node in the tree can be linked to another node representing a token on which it depends. Although a dependency tree is described, various data structures may be used to represent the dependency of tokens in the training image titles 106.

At numeral 3, the dependency tree can be passed to phrase chunker 204. Phrase chunker 204 may also be an NLP library which can crawl the dependency tree to identify noun phrases (e.g., chunks). For example, phrase chunker 204 can identify the nodes of the dependency tree 202 which represent nouns and then identify one or more nodes which are linked to those noun nodes to identify the noun phrases. The noun phrases identified by the phrase chunker 204 are then stored at numeral 4 as training phrases 110. As discussed, the training phrases are multi-word phrases describing the content of the corresponding training image. As these training phrases are based on ground truth training image titles, the training phrases are also treated as ground truth phrases. In some embodiments, the title parser can iteratively process all of the training image titles from training image titles 106. In some embodiments, the title parser can process the training image titles in parallel.

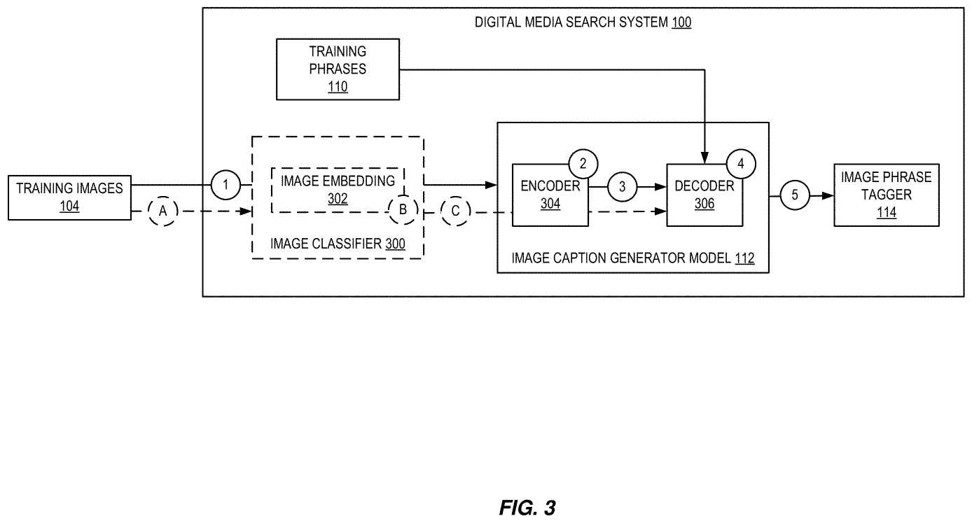

FIG. 3 illustrates a diagram of a process of training an image phrase tagger in accordance with one or more embodiments. As shown in FIG. 3, during a training phase, the training images 104 can be provided to digital media search system 100. In some embodiments, the digital media search system 100 can include a training engine that is configured to teach, guide, tune, and/or train one or more neural networks, such as image caption generator model 112. Although depicted as part of digital media search system 100, in some embodiments, training of the image caption generator model 112 may be provided by a separate system, such as a machine learning system, training system, etc.

At numeral 2, the training images 104 are passed to image caption generator model 112. The image caption generator model can include an encoder 304 and decoder 306. In some embodiments, encoder 304 is a deep convolutional neural network (CNN) which generates an embedding for the training images (e.g., a vector representation). For example, the encoder can be pre-trained in image classification tasks. Alternatively, the encoding of the training images can be performed by a separate image classifier 300. The image classifier 300 can receive the training images 104 at A. The image classifier can be a recurrent neural network (RNN)-based classifier, CNN, or other image classifier, which generates image embeddings 302, as shown at B.

The output of the encoder 304 can be passed to decoder 306 at numeral 3. Alternatively, the image classifier 300 can pass the image embeddings 302 to the decoder 306 at C. Decoder 306 can include an RNN which predicts phrases corresponding to the image embeddings 302. In some embodiments, the decoder 306 is a long short-term memory network. The decoder can then be trained at numeral 4 based on a loss function comparing the ground truth training phrases 110 to the predicted phrases generated by the decoder 306. In some embodiments, training may be performed end-to-end, depending on the implementation of image caption generator model 112. Training may be performed over several epochs until the performance of the image caption generator reaches an acceptable level of accuracy. Once trained, the trained model is output at numeral 5 as image phrase tagger 114.

Although a particular image caption generator model implementation is illustrated in FIG. 3, in various embodiments any image caption generator model may be used.

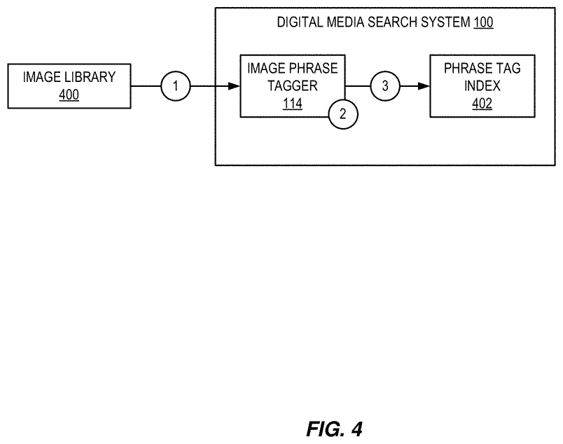

FIG. 4 illustrates a diagram of a process of generating a phrase index for an image library in accordance with one or more embodiments. As discussed, once the image phrase tagger 114 has been created, it can be used to automatically tag images from an image library 400. As shown in FIG. 4, the image library can be provided to digital media search system 100 at numeral 1. In some embodiments, the image library can be provided as part of a tagging request received via an interface, such as an application programming interface (API), console, or other user interface. The image library may be provided via a reference to a network accessible storage location, such as an endpoint of a storage service in a cloud provider network, a location in a file system (e.g., folder or folders, removable media drive, hard disk drive, etc.). In some embodiments, the image library may be maintained by an image service that manages, catalogues, stores, etc. their own images or those belonging to users or other entities.

The image phrase tagger can process each image from the image library and generate one or more phrase tags based on the content represented in each image. In some embodiments, image phrase tagger 114 is a generative model. This enables image phrase tagger to generate phrase tags that were not included in the training phrases used to train the image phrase tagger, as described above. For example, once the image phrase tagger 114 has learned the concept “purple” and the concept “rose”, it can generate a phrase tag of “purple rose” for an image that includes a representation of a purple rose, even if the image phrase tagger was never specifically trained to identify purple roses. or other storage location.

In some embodiments, the image phrase tagger 114 can predict multiple phrase tags for a particular image. For example, candidate phrases may be identified using a beam search mechanism, where a first LSTM cell of the image phrase tagger predicts N phrases, then these are input to the next LSTM cell so which predicts N*N phrases. The image phrase tagger selects the top N phrases from the set of N*N phrases. The beam size can vary based on implementation. In some embodiments, the beam search mechanism is implemented after a softmax activation layer for each prediction time step in the image phrase tagger. Once the N phrases have been predicted for all of the images in the image library, then at numeral 3, a phrase tag index of the image library and their associated phrase tags can be generated.

Once the phrase tag index 402 has been generated, the phrase tag index can be used by the digital media search system 100 to respond to queries for images from image library 400. Additionally, or alternatively, the phrase tag index can be provided to the owner or manager of the image library (e.g., an image service) which can enable the image library to be searched using the phrase tag index 402. For example, an image service may request that digital media search system 100 generate a phrase tag index 402 for their image library 400. Once completed, the phrase tag index 402 can be returned to the image service and incorporated into the image service's own search interface.

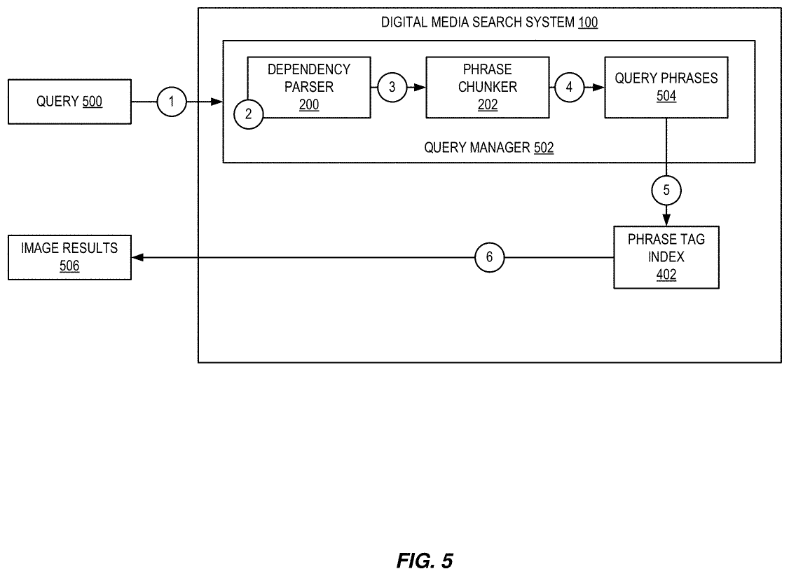

FIG. 5 illustrates a diagram of a process of querying phrase-tagged images using a phrase index in accordance with one or more embodiments. As shown in FIG. 5, a query 500 can be received by digital media search system 100 at numeral 1. The query 500 can be a text query received via a user interface provided by digital media search system 100 or other application, such as an API, a search bar of a digital design application, a search interface of a stock image library, or other user interface. The query can be received by query manager 502. Query manager 502 can include dependency parser 200 and phrase chunker 202. The dependency parser 200 and phrase chunker 204 may be the same implementation as used to generate the training phrases from the training image titles, described above.

At numeral 2, the dependency parser 200 can generate a dependency tree for the query 500. This may be generated similarly to the dependency tree described above with respect at least to FIG. 2. At numeral 3, the dependency tree can be passed to phrase chunker 204 which can identify noun phrases from the dependency tree. The noun phrases can be output at numeral 4 as query phrases 504. For example, if an input query is “black rose on a white background,” the dependency parser generates a dependency tree which identifies “rose” and “background” as nouns that are modified by “black” and “white,” respectively. Phrase chunker 204, then identifies the noun phrases “black rose” and “white background” as the query phrases 504.

The query phrases 504 can then be used to search phrase tag index 402, at numeral 5. The phrase tag index can be a data structure which links images to their associated phrase tags. For example, a pointer to an image may be a key and the corresponding values to that key may be that image's associated phrase tags. The phrase tag index can be searched using the query phrases to identify any matching images. The image result set 506, including zero or more matching images, can then be returned at numeral 6. In some embodiments, a thumbnail view of the images in the image result set 506 can be presented to the user, e.g., as a grid, and the user may select one or more of the images to view, add to a new or existing design project, etc.

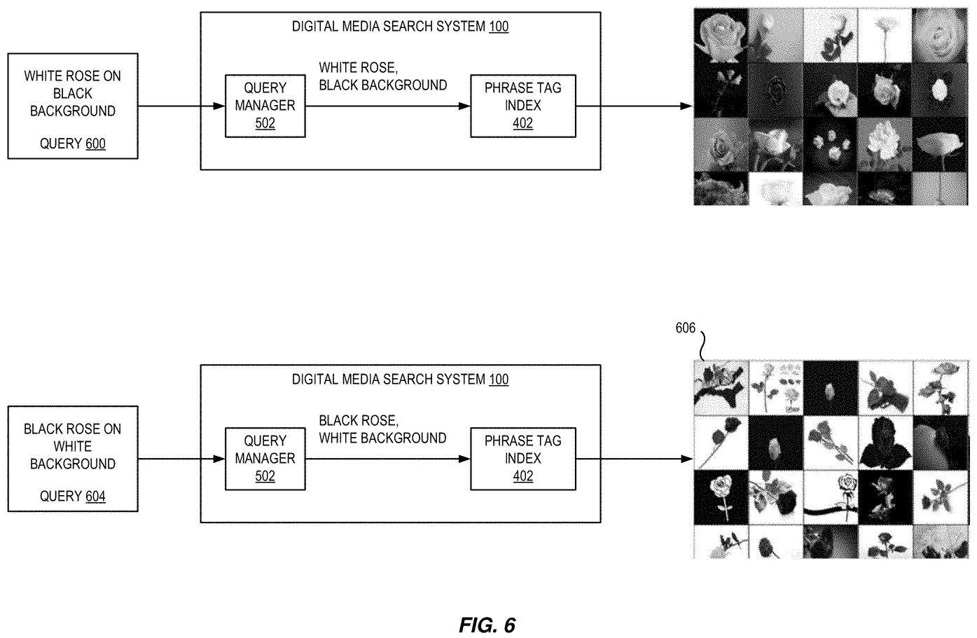

FIG. 6 illustrates a diagram of example query processing in accordance with one or more embodiments. As shown in FIG. 6, an example query 600 is received which includes the query “white rose on black background.” The query manager 502 can identify query phrases “white rose” and “black background,” as described above. These query phrases can be used to search phrase tag index 402, yielding image result set 602. As shown, image result set 602 predominantly includes images of white roses on black backgrounds, with a handful of outliers including different colored backgrounds or different colored roses.

Additionally, FIG. 6 shows a second example query 604 which includes the query “black rose on white background.” As discussed, the query manager 502 can identify query phrases “black rose” and “white background,” as described above. These query phrases can be used to search phrase tag index 402, yielding image result set 606. As shown, image result set 606 is different from image result set 602, in that it predominantly includes images of black roses on white backgrounds, with a handful of outliers including different colored backgrounds or different colored roses.

In traditional autotagger systems, the images would have been tagged with single-word tags and the queries would have been tokenized into single word query tags. As a result, the tokenized query for both example query 600 and 604 would have been the same (e.g., “white,” “rose,” “black,” and “background”) and would have resulted in the same image result set. As such, the result set would have included images tagged with rose, which may include various different colors of roses. The result set also would have included images with any objects that resulted in a “black” or “white” tag being associated with the image. As a result, the image result set in a traditional tagging system would have been predominantly outliers, requiring the user to do further manual sorting of the results to find appropriate images.

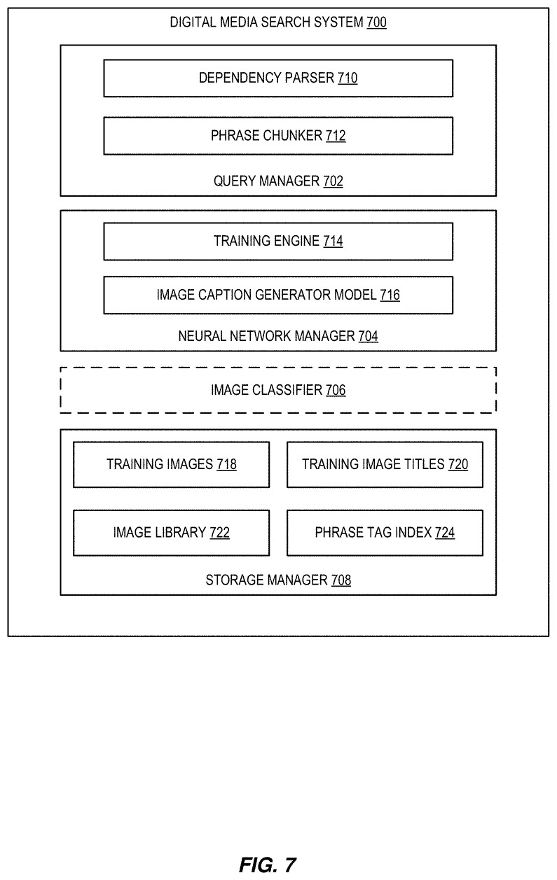

FIG. 7 illustrates a schematic diagram of digital media search system (e.g., “digital media search system” described above) in accordance with one or more embodiments. As shown, the digital media search system 700 may include, but is not limited to, query manager 702, neural network manager 704, optionally image classifier 706, and storage manager 708. The query manager 702 includes dependency parser 710 and phrase chunker 712. The neural network manager 704 includes a training engine 714 and image caption generator model 716. The storage manager 708 includes training images 718, training image titles 720, image library 722, and phrase tag index 724.

As illustrated in FIG. 7, the digital media search system 700 includes a query manager 702. The query manager 702 can receive an input query and coordinate other components of the digital media search system 700 to identify one or more digital media items (e.g., digital images, digital videos, etc.) responsive to the query. For example, as discussed, an input query can include text-based input that includes one or more descriptive phrases of the digital media to be identified. The query can be passed to dependency parser 710 which may include an NLP library which analyzes the input query and generates a dependency tree. The dependency parser can tokenize the input query and identify a party of speech associated with each token. Each node in the dependency tree can represent a token and identify the part of speech of that token. Additionally, the relationships between nodes in the dependency tree can be determined syntactically, e.g., based on a language model associated with the language of the input query, and each connection between nodes can identify the type of dependency between the two corresponding tokens (e.g., modifier, compound word, etc.). Phrase chunker 712 can identify phrases based on the dependency tree. For example, noun phrases (e.g., phrases comprising a noun and its modifier(s)) can be identified by identifying a noun node and any other nodes that are identified as modifiers of that noun.

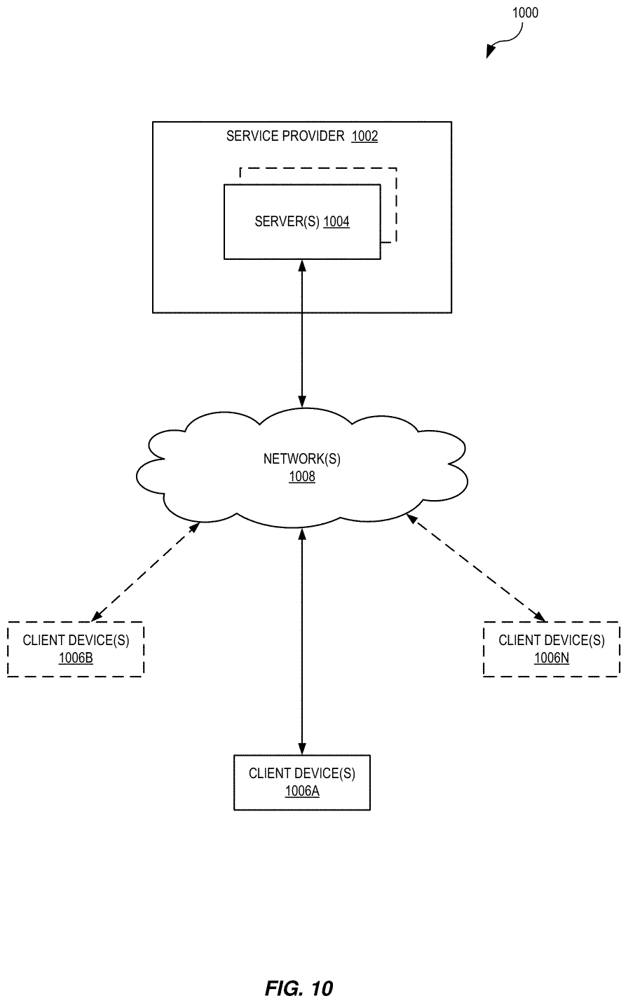

As further illustrated in FIG. 10, the digital media search system 700 includes the neural network manager 704 that manages the training engine 714. The training engine 714 can teach, guide, tune, and/or train one or more neural networks. In particular, the training engine 714 can train a neural network based on a plurality of training data (e.g., training images 718 and training image titles 720). As discussed, the training images 718 may include digital images including representations of objects, scenes, etc. the contents of which are described using short descriptive phrases in the corresponding training image titles 720. More specifically, the training engine 714 can access, identify, generate, create, and/or determine training input and utilize the training input to train and fine-tune a neural network. For instance, the training engine 714 can train the image capture generator model, as discussed above in detail with respect to FIGS. 1-3.

In addition, and as mentioned directly above, the neural network manager 704 can manage the training and the use of various neural networks. In particular, the neural network manager 704 manages the training and utilization of the image caption generator model 716. The image caption generator model 716 can include one or all of the features and functions described above with respect to the image caption generator model 112 and image phrase tagger 114 (e.g., a particular trained implementation of the image caption generator model 112) of FIGS. 1, 3, and 4. Moreover, in one or more embodiments the phrase tags can be generated using other types of networks. In some embodiments, neural network manager 704 can manage image classifier 706. As described above, image classifier 706 may optionally be used to generate image embeddings for training images that can then be provided to image caption generator model 716 during training. Image classifier 706 may be a CNN, RNN, or other image classification model.

As illustrated in FIG. 7, the digital media search system 700 also includes the storage manager 708. The storage manager 708 maintains data for the digital media search system 700. The storage manager 708 can maintain data of any type, size, or kind as necessary to perform the functions of the digital media search system 700. The storage manager 708, as shown in FIG. 7, includes the training images 718 and training image titles 720. The training images 718 can include a plurality of digital training images, each associated with a corresponding training image title 720, as discussed in additional detail above. In particular, in one or more embodiments, the training images 718 include digital training images utilized along with the corresponding training image titles 720 by the neural network training engine 714 to train one or more neural networks to generate phrase tags for input images.

As further illustrated in FIG. 7, the storage manager 708 also includes image library data 722. The image library data 722 may include a plurality of digital media items, including digital images, digital videos, etc. The image library data 722 may include public image libraries, such as stock image libraries, and/or private image libraries maintained by a design firm, private company, or other entity. The storage manager 708 may further include phrase tag index 724. The phrase tag index 724 may be an index of phrase tags generated for the image library data 722 using image caption generator model 716. The phrase tag index may be used by the query manager to search for digital media from the image library based on a received query, as discussed above.

Each of the components 704-708 of the digital media search system 700 and their corresponding elements (as shown in FIG. 7) may be in communication with one another using any suitable communication technologies. It will be recognized that although components 702-708 and their corresponding elements are shown to be separate in FIG. 7, any of components 702-708 and their corresponding elements may be combined into fewer components, such as into a single facility or module, divided into more components, or configured into different components as may serve a particular embodiment.

The components 702-708 and their corresponding elements can comprise software, hardware, or both. For example, the components 702-708 and their corresponding elements can comprise one or more instructions stored on a computer-readable storage medium and executable by processors of one or more computing devices. When executed by the one or more processors, the computer-executable instructions of the digital media search system 700 can cause a client device and/or a server device to perform the methods described herein. Alternatively, the components 704-708 and their corresponding elements can comprise hardware, such as a special purpose processing device to perform a certain function or group of functions. Additionally, the components 704-708 and their corresponding elements can comprise a combination of computer-executable instructions and hardware.

Furthermore, the components 702-708 of the digital media search system 700 may, for example, be implemented as one or more stand-alone applications, as one or more modules of an application, as one or more plug-ins, as one or more library functions or functions that may be called by other applications, and/or as a cloud-computing model. Thus, the components 702-708 of the digital media search system 700 may be implemented as a stand-alone application, such as a desktop or mobile application. Furthermore, the components 702-708 of the digital media search system 700 may be implemented as one or more web-based applications hosted on a remote server. Alternatively, or additionally, the components of the digital media search system 700 may be implemented in a suit of mobile device applications or “apps.” To illustrate, the components of the digital media search system 700 may be implemented in any application that allows search of digital media, including but not limited to applications in ADOBE CREATIVE CLOUD, such as ADOBE PHOTOSHOP. “ADOBE”, “CREATIVE CLOUD”, and “PHOTOSHOP” are registered trademarks of Adobe Systems Incorporated in the United States and/or other countries.

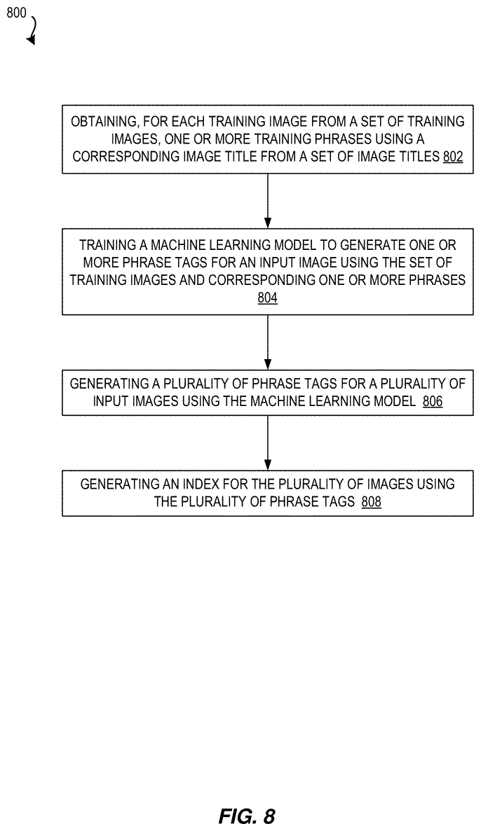

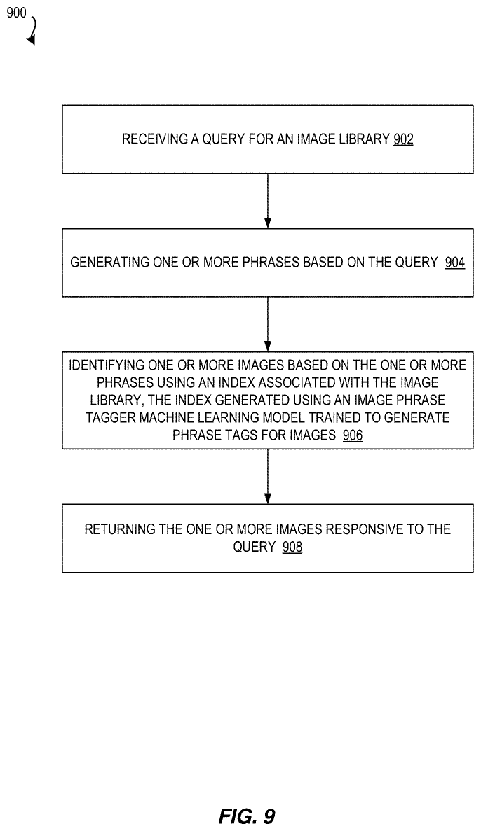

FIGS. 1-7, the corresponding text, and the examples, provide a number of different systems and devices that allows a user to facilitate selection of target individuals within digital visual media. In addition to the foregoing, embodiments can also be described in terms of flowcharts comprising acts and steps in a method for accomplishing a particular result. For example, FIGS. 8 and 9 illustrate flowcharts of exemplary methods in accordance with one or more embodiments. The methods described in relation to FIGS. 8 and 9 may be performed with less or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart of a series of acts in a method of multi-word phrase tagging of digital media in accordance with one or more embodiments. In one or more embodiments, the method 800 is performed in a digital medium environment that includes the digital media search system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of obtaining, by a digital media search system, for each training image from a set of training images, one or more training phrases using a corresponding image title from a set of image titles. In some embodiments, the training data used to train an image caption generator model and can include pairs of training images and training image titles (e.g., a set of training images and a corresponding set of training image titles). The training image titles can be provided to a dependency parser to generate a dependency tree for each title from the set of training image titles. From the dependency tree for each title, the one or more phrases can be identified. The one or more phrases can include noun phrases (e.g., comprising a noun and a modifier of that noun) that describe the contents of the image.

As illustrated in FIG. 8, the method 800 includes an act 804 of training, by the digital media search system, a machine learning model to generate one or more phrase tags for an input image using the set of training images and corresponding one or more phrases. In some embodiments, training the machine learning model can include processing each training image using an image recognition model to obtain a set of training image embeddings and training the machine learning model using the set of training image embeddings and the corresponding one or more phrases, wherein the machine learning model is an image caption generator model. As discussed, in some embodiments, the machine learning model can include an end-to-end image caption generator model or an image caption generator model that receives image embeddings from a separate image classifier. In some embodiments, a beam search parameter associated with the machine learning model can be adjusted to predict multiple captions for each training image.

As illustrated in FIG. 8, the method 800 includes an act 806 of generating, by the digital media search system, a plurality of phrase tags for a plurality of input images using the machine learning model. For example, an image library can be analyzed using the trained machine learning model to generate phrase tags for each image in the image library. In such an application, the trained machine learning model is an image phrase tagger which operates similarly to an autotagger (e.g., generating phrase tags and associating them with an input image).

As illustrated in FIG. 8, the method 800 includes an act 808 of generating, by the digital media search system, an index for the plurality of images using the plurality of phrase tags. As discussed, an index may comprise various data structures which can associate the image phrase tags with their corresponding image or images. When a query is received, the query can be divided into phrases similarly to the phrase chunking described above that is performed during training. These query phrases can then be used to search the index and any matching images can be returned to the requestor. As discussed, the matching images may be returned by rendering them in a user interface for the user to review.

In some embodiments, the method further includes an act of providing, by the digital media search system, the index to an image service associated with the plurality of images. In some embodiments, the method further includes an act of receiving, by the digital media search system, the set of training images and corresponding set of image titles from the image service. As discussed, an image service may own and/or maintain the image library. The image service may manage, catalogue, store, etc. their own images or those belonging to users or other entities.

In some embodiments, the method further includes an act of receiving, by the digital media search system, a query. The query can include a text query which describes which images are being searched for. The method can further include an act of dividing, by the digital media search system, the query into one or more query phrases. As discussed, the same techniques used to generate training phrases can be used to generate query phrases. The method can further include an act of searching, by the digital media search system, the index using the one or more query phrases and returning one or more images based on the search.

FIG. 9 illustrates a flowchart of a series of acts in a method of searching digital media using multi-word phrase tags in accordance with one or more embodiments. In one or more embodiments, the method 900 is performed in a digital medium environment that includes the digital media search system 700. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of receiving, by a digital media search system, a query for an image library. As discussed, the query can a text query received through a user interface. In some embodiments, the query can be a audio query that is transcribed using natural language processing techniques.

As illustrated in FIG. 9, the method 900 includes an act 904 of generating, by the digital media search system, one or more phrases based on the query. As discussed, the one or more phrases (e.g., query phrases) can be generated using the same techniques as described above with respect to generating training phrases. For example, an NLP library can be used to generate a dependency tree for the query. From the dependency tree, the one or more phrases can be identified. The one or more phrases include noun phrases.

As illustrated in FIG. 9, the method 900 includes an act 906 of identifying, by the digital media search system, one or more images based on the one or more phrases using an index associated with the image library, the index generated using an image phrase tagger machine learning model trained to generate phrase tags for images. As discussed, the image phrase tagger machine learning model can be a trained image caption generator model which has been trained to generate phrase tags rather than full captions for input images. In some embodiments, training may include obtaining, for each training image from a set of training images, one or more training phrases using a corresponding image title from a set of image titles, training a machine learning model to generate one or more phrase tags for an input image using the set of training images and corresponding one or more phrases, generating a plurality of phrase tags for a plurality of input images using the machine learning model, and generating an index for the plurality of images using the plurality of phrase tags. As discussed, to obtain the training data by providing the set of image titles to a dependency parser, the dependency parser to generate a dependency tree for each title from the set of image titles. Using the dependency tree, training phrases can be identified which include noun phrases that describe what is depicted in the images.

As illustrated in FIG. 9, the method 900 includes an act 908 of returning, by the digital media search system, the one or more images responsive to the query. As discussed, the one or more images can be returned by displaying them to the user. In some embodiments, links (e.g., hypertext links) to the one or more images can be returned. In some embodiments, the images may be returned to the user through same graphical user interface through which the query was received.

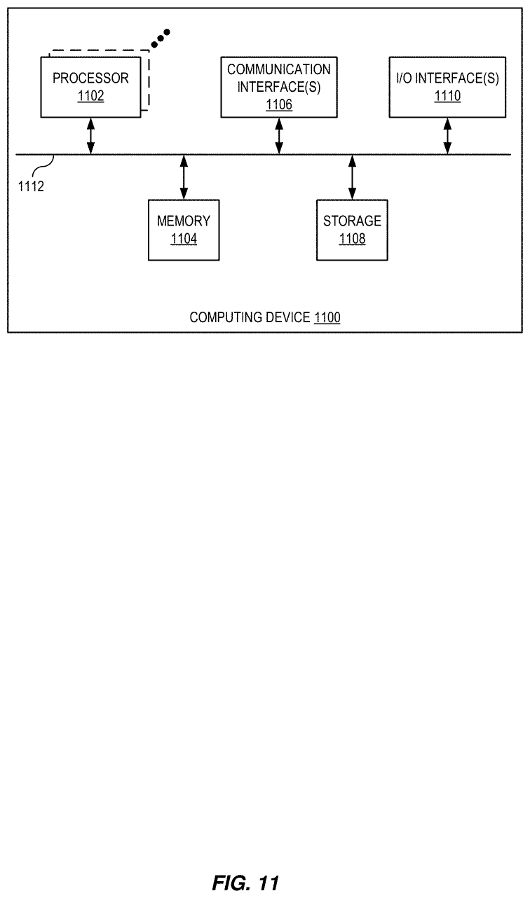

FIG. 10 illustrates a schematic diagram of an exemplary environment 1000 in which the digital media search system 700 can operate in accordance with one or more embodiments. In one or more embodiments, the environment 1000 includes a service provider 1002 which may include one or more servers 1004 connected to a plurality of client devices 1006A-1006N via one or more networks 1008. The client devices 1006A-1006N, the one or more networks 1008, the service provider 1002, and the one or more servers 1004 may communicate with each other or other components using any communication platforms and technologies suitable for transporting data and/or communication signals, including any known communication technologies, devices, media, and protocols supportive of remote data communications, examples of which will be described in more detail below with respect to FIG. 11.

Although FIG. 10 illustrates a particular arrangement of the client devices 1006A-1006N, the one or more networks 1008, the service provider 1002, and the one or more servers 1004, various additional arrangements are possible. For example, the client devices 1006A-1006N may directly communicate with the one or more servers 1004, bypassing the network 1008. Or alternatively, the client devices 1006A-1006N may directly communicate with each other. The service provider 1002 may be a public cloud service provider which owns and operates their own infrastructure in one or more data centers and provides this infrastructure to customers and end users on demand to host applications on the one or more servers 1004. The servers may include one or more hardware servers (e.g., hosts), each with its own computing resources (e.g., processors, memory, disk space, networking bandwidth, etc.) which may be securely divided between multiple customers, each of which may host their own applications on the one or more servers 1004. In some embodiments, the service provider may be a private cloud provider which maintains cloud infrastructure for a single organization. The one or more servers 1004 may similarly include one or more hardware servers, each with its own computing resources, which are divided among applications hosted by the one or more servers for use by members of the organization or their customers.

Similarly, although the environment 1000 of FIG. 10 is depicted as having various components, the environment 1000 may have additional or alternative components. For example, the environment 1000 can be implemented on a single computing device with the digital media search system 700. In particular, the digital media search system 700 may be implemented in whole or in part on the client device 1002A.

As illustrated in FIG. 10, the environment 1000 may include client devices 1006A-1006N. The client devices 1006A-1006N may comprise any computing device. For example, client devices 1006A-1006N may comprise one or more personal computers, laptop computers, mobile devices, mobile phones, tablets, special purpose computers, TVs, or other computing devices, including computing devices described below with regard to FIG. 11. Although three client devices are shown in FIG. 10, it will be appreciated that client devices 1006A-1006N may comprise any number of client devices (greater or smaller than shown).

Moreover, as illustrated in FIG. 10, the client devices 1006A-1006N and the one or more servers 1004 may communicate via one or more networks 1008. The one or more networks 1008 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 1008 may be any suitable network over which the client devices 1006A-1006N may access service provider 1002 and server 1004, or vice versa. The one or more networks 1008 will be discussed in more detail below with regard to FIG. 11.

In addition, the environment 1000 may also include one or more servers 1004. The one or more servers 1004 may generate, store, receive, and transmit any type of data, including training image data 718, training image title data 720, image library data 722, phrase tag index 724, input queries, output image sets, or other information. For example, a server 1004 may receive data from a client device, such as the client device 1006A, and send the data to another client device, such as the client device 1002B and/or 1002N. The server 1004 can also transmit electronic messages between one or more users of the environment 1000. In one example embodiment, the server 1004 is a data server. The server 1004 can also comprise a communication server or a web-hosting server. Additional details regarding the server 1004 will be discussed below with respect to FIG. 11.

As mentioned, in one or more embodiments, the one or more servers 1004 can include or implement at least a portion of the digital media search system 700. In particular, the digital media search system 700 can comprise an application running on the one or more servers 1004 or a portion of the digital media search system 700 can be downloaded from the one or more servers 1004. For example, the digital media search system 700 can include a web hosting application that allows the client devices 1006A-1006N to interact with content hosted at the one or more servers 1004. To illustrate, in one or more embodiments of the environment 1000, one or more client devices 1006A-1006N can access a webpage supported by the one or more servers 1004. In particular, the client device 1006A can run a web application (e.g., a web browser) to allow a user to access, view, and/or interact with a webpage or website hosted at the one or more servers 1004.

Upon the client device 1006A accessing a webpage or other web application hosted at the one or more servers 1004, in one or more embodiments, the one or more servers 1004 can provide access to one or more digital images (e.g., the image library 722) stored at the one or more servers 1004. Moreover, the client device 1006A can receive a request (i.e., via user input) to search for particular images in the image library and provide the request (e.g., as a text query) to the one or more servers 1004. Upon receiving the request, the one or more servers 1004 can automatically perform the methods and processes described above to identify images from the image library based on the query phrases identified from the received query and the phrase tag index that was previously constructed for the image library. The one or more servers 1004 can provide matching images based on the query, to the client device 1006A for display to the user.

As just described, the digital media search system 700 may be implemented in whole, or in part, by the individual elements 1002-1008 of the environment 1000. It will be appreciated that although certain components of the digital media search system 700 are described in the previous examples with regard to particular elements of the environment 1000, various alternative implementations are possible. For instance, in one or more embodiments, the digital media search system 700 is implemented on any of the client devices 1006A-N. Similarly, in one or more embodiments, the digital media search system 700 may be implemented on the one or more servers 1004. Moreover, different components and functions of the digital media search system 700 may be implemented separately among client devices 1006A-1006N, the one or more servers 1004, and the network 1008.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that one or more computing devices such as the computing device 1100 may implement the image processing system. As shown by FIG. 11, the computing device can comprise a processor 1102, memory 1104, one or more communication interfaces 1106, a storage device 1108, and one or more I/O devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more input or output (“I/O”) devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A computer-implemented method comprising:
obtaining, for each training image from a set of training images, one or more training phrases using a corresponding image title from a set of image titles;
training a machine learning model to generate one or more phrase tags for an input image using the set of training images and corresponding one or more phrases;
generating a plurality of phrase tags for a plurality of input images using the machine learning model; and
generating an index for the plurality of images using the plurality of phrase tags.

2. The computer-implemented method of claim 1, wherein obtaining, for each training image from a set of training images, one or more phrases using a corresponding image title from a set of image titles, further comprises:
providing the set of image titles to a dependency parser, the dependency parser to generate a dependency tree for each title from the set of image titles.

3. The computer-implemented method of claim 2, further comprising:
identifying the one or more phrases based on the dependency tree, the one or more phrases including noun phrases.

4. The computer-implemented method of claim 1, wherein training a machine learning model to generate one or more phrase tags for an input image using the set of training images and corresponding one or more phrases further comprises:
processing each training image using an image recognition model to obtain a set of training image embeddings; and
training the machine learning model using the set of training image embeddings and the corresponding one or more phrases, wherein the machine learning model is an image caption generator model.

5. The computer-implemented method of claim 1, wherein training a machine learning model to generate one or more phrase tags for an input image using the set of training images and corresponding one or more phrases further comprises:
adjusting a beam search to predict multiple captions for each training image.

6. The computer-implemented method of claim 1, further comprising:
providing the index to an image service associated with the plurality of images.

7. The computer-implemented method of claim 6, further comprising:
receiving the set of training images and corresponding set of image titles from the image service.

8. The computer-implemented method of claim 1, further comprising:
receiving a query;
dividing the query into one or more query phrases;
searching the index using the one or more query phrases; and
returning one or more images based on the search.

9. A non-transitory computer readable storage medium including instructions stored thereon which, when executed by at least one processor, cause the at least one processor to:
obtain, for each training image from a set of training images, one or more training phrases using a corresponding image title from a set of image titles;
train a machine learning model to generate one or more phrase tags for an input image using the set of training images and corresponding one or more phrases;
generate a plurality of phrase tags for a plurality of input images using the machine learning model; and
generate an index for the plurality of images using the plurality of phrase tags.

10. The non-transitory computer readable storage medium of claim 9, wherein to obtain, for each training image from a set of training images, one or more phrases using a corresponding image title from a set of image titles, the instructions, when executed, further cause the at least one processor to:
pass the set of image titles to a dependency parser, the dependency parser to generate a dependency tree for each title from the set of image titles.

11. The non-transitory computer readable storage medium of claim 10, wherein the instructions, when executed, further cause the at least one processor to:
identify the one or more phrases based on the dependency tree, the one or more phrases including noun phrases.

12. The non-transitory computer readable storage medium of claim 9, wherein to train a machine learning model to generate one or more phrase tags for an input image using the set of training images and corresponding one or more phrases, the instructions, when executed, further cause the at least one processor to:
process each training image using an image recognition model to obtain a set of training image embeddings; and
train the machine learning model using the set of training image embeddings and the corresponding one or more phrases, wherein the machine learning model is an image caption generator model.

13. The non-transitory computer readable storage medium of claim 9, wherein to train a machine learning model to generate one or more phrase tags for an input image using the set of training images and corresponding one or more phrases, the instructions, when executed, further cause the at least one processor to:
adjust a beam search to predict multiple captions for each training image.

14. The non-transitory computer readable storage medium of claim 9, wherein the instructions, when executed, further cause the at least one processor to:
provide the index to an image service associated with the plurality of images.

15. The non-transitory computer readable storage medium of claim 14, wherein the instructions, when executed, further cause the at least one processor to:
receive the set of training images and corresponding set of image titles from the image service.

16. The non-transitory computer readable storage medium of claim 9, wherein the instructions, when executed, further cause the at least one processor to:
receive a query;
divide the query into one or more query phrases;
search the index using the one or more query phrases; and
return one or more images based on the search.

17. A computer-implemented method comprising:
receiving a query for an image library;
generating one or more phrases based on the query;
identifying one or more images based on the one or more phrases using an index associated with the image library, the index generated using an image phrase tagger machine learning model trained to generate phrase tags for images; and
returning the one or more images responsive to the query.

18. The computer-implemented method of claim 17, wherein the image phrase tagger machine learning model is trained to generate the phrase tags for images by:
obtaining, for each training image from a set of training images, one or more training phrases using a corresponding image title from a set of image titles;
training a machine learning model to generate one or more phrase tags for an input image using the set of training images and corresponding one or more phrases;
generating a plurality of phrase tags for a plurality of input images using the machine learning model; and
generating an index for the plurality of images using the plurality of phrase tags.

19. The computer-implemented method of claim 18, wherein obtaining, for each training image from a set of training images, one or more phrases using a corresponding image title from a set of image titles, further comprises:
providing the set of image titles to a dependency parser, the dependency parser to generate a dependency tree for each title from the set of image titles.

20. The computer-implemented method of claim 19, further comprising:
identifying the one or more phrases based on the dependency tree, the one or more phrases including noun phrases.
